(19) United States
(12) Patent Application Publication
(10) Pub. No.: US 2020/0062307 A1
(43) Pub. Date: Feb. 27, 2020

(54) BEHAVIOR CONTROL APPARATUS FOR VEHICLE AND METHOD THEREOF

(71) Applicants: HYUNDAI MOTOR COMPANY, Seoul (KR); KIA MOTORS CORPORATION, Seoul (KR)

(72) Inventor: Kyung Deuk MIN, Hwaseongsi (KR)

(73) Assignees: HYUNDAI MOTOR COMPANY, Seoul (KR); KIA MOTORS CORPORATION, Seoul (KR)

(21) Appl. No.: 16/179,180

(22) Filed: Nov. 2, 2018

(30) Foreign Application Priority Data
Aug. 23, 2018 (KR) 10-2018-0098573

(51) Int. Cl. B62D 15/02; B60T 8/1764; B62D 6/00; B60W 30/12; B60W 10/20; B60W 10/18

(52) U.S. Cl. CPC B62D 15/025; B60T 8/1764; B62D 6/003; B60W 30/12; B60W 10/20; B60W 2550/143; B60W 2420/42; B60W 2550/406; B60W 2550/402; B60W 2550/141; B60W 10/18

(57) ABSTRACT

An apparatus and a method for controlling a behavior of a vehicle that travels on a road. The behavior control apparatus for a vehicle and the method provide that the driver may safely return the vehicle to a paved road surface while compensating for the behavior of the vehicle based on an external force generated by deviation of one-side wheels of the vehicle from the paved road surface.

### CROSS-REFERENCE TO RELATED APPLICATION

This application claims priority to and the benefit of Korean Patent Application No. 10-2018-0098573, filed on Aug. 23, 2018, the entire contents of which are incorporated herein by reference.

### FIELD

The present disclosure relates to an apparatus and a method for controlling a behavior of a vehicle that travels on a road.

### BACKGROUND

The statements in this section merely provide background information related to the present disclosure and may not constitute prior art.

In general, vehicles travel on paved roads paved with asphalt or concrete, but people or bicycles use unpaved areas mainly covered with dirt or pebbles beyond the boundary lines of the paved roads.

When wheels on one side of a vehicle, which is traveling, deviate from the paved road due to the carelessness of the driver and enter the non-paved area, an external force is generated due to a step (or height difference) between the vehicle road and the adjacent non-paved road and a lateral gradient of the road, and in this case, the external force accelerates deviation of the vehicle.

In this way, when the wheels of the vehicle, which is traveling, deviate from the paved road, it is not easy for the vehicle to return to the paved road only with the manipulation of the driver.

The conventional technology of controlling a behavior of the vehicle fails to consider the case in which the one-side wheels of the vehicle, which is traveling, deviate from the paved road and enter the non-paved area.

Accordingly, according to the conventional technology, because the behavior of the vehicle is controlled in a state in which an external force generated due to a step (height difference) between the road and the adjacent non-road and the lateral gradient of the road is not considered, the manipulation of the driver is not assisted so that the vehicle that deviated from the paved road cannot safely return to the paved road.

### SUMMARY

The present disclosure addresses the above-mentioned problems occurring in the prior art while advantages achieved by the prior art are maintained intact.

An aspect of the present disclosure provides a behavior control apparatus for a vehicle and a method thereof, in which the driver may safely return the vehicle to a paved road while compensating for the behavior of the vehicle, which is traveling, in consideration of an external force delivered from one-side wheels due to deviation of the one-side wheels of the vehicle from the road.

The technical problems to be solved by the present inventive concept are not limited to the aforementioned problems, and any other technical problems not mentioned herein will be clearly understood from the following description by those skilled in the art to which the present disclosure pertains.

In one form, the present disclosure provides a behavior control apparatus for a vehicle, including: a deviation detecting device configured to determine whether one-side wheels arranged on one side of the vehicle deviate from a first road surface (e.g., a paved portion) of a road on which the vehicle travels, and a controller configured to detect a first external force generated due to a step between the first road surface and a second road surface (e.g., an unpaved portion next to the paved portion) adjacent to the first road surface of the road, and configured to detect a lateral gradient of the road and to calculate and cause a steering torque corresponding to the first external force to assist steering of a driver.

The controller may apply a biased braking to second-side wheels arranged opposite to the first-side wheels of the vehicle, and to offset a difference between rolling resistances caused by the step between the first road surface and the second road surface and by different materials on the first and second road surfaces.

The controller may calculate a second external force based on a steering torque generated from manipulation of a steering wheel by the driver and a force delivered from the first-side wheels of the vehicle.

The deviation detecting device may detect a road boundary from a front image of the vehicle based on a current location of the vehicle and map information.

The deviation detecting device may determine the deviation of the vehicle from the first road surface based on a change to a movement of the vehicle generated when the first-side wheels across the road boundary.

The deviation detecting device may determine that the first-side wheels of the vehicle deviated from the first road surface when a difference between a deviation of a gravitational acceleration of the first-side wheels of the vehicle and a deviation of a gravitational acceleration of the second-side wheels arranged opposite to the first-side wheels of the vehicle exceeds a reference value.

The deviation detecting device may determine that the first-side wheels of the vehicle deviated from the first road surface when a suspension stroke of the first-side wheels of the vehicle exceeds a threshold value.

The deviation detecting device may determine that the first-side wheels of the vehicle deviated from the first road surface when a difference between a speed of the first-side wheels of the vehicle and a speed of the second-side wheels arranged opposite to the first-side wheels of the vehicle exceeds a threshold value.

In another form, the present disclosure provides a method for controlling a behavior of a vehicle. In particular, the method includes: detecting deviation of first-side wheels of the vehicle, which is traveling, from a first road surface; detecting a first external force generated due to a step between the first road surface and a second road surface adjacent to the first road surface of the road; detecting a lateral gradient of the road; and calculating and causing a steering torque corresponding to the first external force to assist steering of a driver.

The method may further include: applying a biased braking to second-side wheels arranged opposite to the first-side wheels of the vehicle, and offsetting a difference between rolling resistances caused by the step between the first road surface and the second road surface and by different materials on the first and second road surfaces.

The detecting the external force may include detecting a second external force based on a steering torque generated from manipulation of a steering wheel by the driver and a force delivered from the first-side wheels of the vehicle.

The detecting the deviation may include: detecting a road boundary from a front image of the vehicle based on a current location of the vehicle and map information.

The detecting the deviation may include determining deviation of the vehicle from the first road surface based on a change to a movement of the vehicle when the first-side wheels across the road boundary.

The detecting the deviation may include determining that the first-side wheels of the vehicle deviated from the first road surface when a difference between a deviation of a gravitational acceleration of the first-side wheels of the vehicle and a deviation of a gravitational acceleration of the second-side wheels of the vehicle exceeds a reference value.

The detecting the deviation may include determining that the first-side wheels of the vehicle deviated from the first road surface when a suspension stroke of the first-side wheels of the vehicle exceeds a threshold value.

The detecting the deviation may include determining that the first-side wheels of the vehicle deviated from the first road surface when a difference between a speed of the first-side wheels of the vehicle and a speed of the second-side wheels of the vehicle exceeds a threshold value.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an exemplary view illustrating a road environment in which a vehicle travels;

FIG. 2 is a schematic diagram of a behavior control system for a vehicle;

FIG. 3 is a schematic diagram of a behavior control apparatus for a vehicle;

FIG. 4 is an exemplary view of a process of calculating a lateral gradient of a paved road; and

FIG. 5 is a flowchart illustrating a method for controlling a behavior of a vehicle.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, exemplary forms of the present disclosure will be described in detail with reference to the accompanying drawings. Further, in the following description of the present disclosure, a detailed description of known functions and configurations incorporated herein will be omitted when it may make the subject matter of the present disclosure rather unclear.

In addition, terms, such as first, second, A, B, (a), (b) or the like may be used herein when describing components of the present disclosure. The terms are provided only to distinguish the components from other components, and the essences, sequences, orders, and numbers of the components are not limited by the terms. In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure.

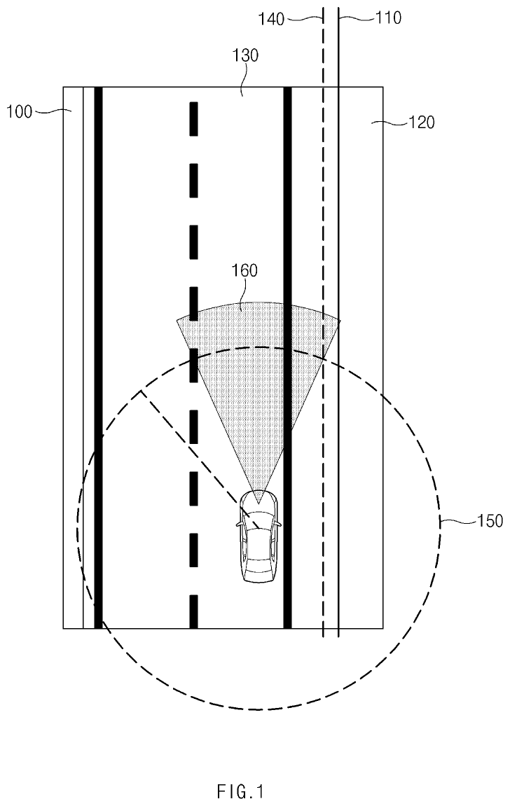

FIG. 1 is an exemplary view illustrating a road environment in which a vehicle, to which the present disclosure is applied, travels.

As illustrated in FIG. 1, the vehicle travels on a paved road surface 130 with four lanes, on which northbound lanes and southbound lanes are separated by a median strip 100, and the left side of a road boundary 110 indicates the paved road surface 130 (e.g., a paved portion of the road) and the right side of the road boundary 110 indicates a non-paved area 120 (e.g., unpaved road surface adjacent to the paved road surface). Then, the paved road surface 130 refers to a road portion paved with asphalt, concrete, or bricks for high-speed travels of vehicles, and the non-paved area refers to an area or a road surface that is not paved and refers to an area in which dirt, pebbles, gravel, grass (lawn or weeds), and the like are covered (also known as a road shoulder, or road berm).

In general, the paved road surface 130 does not have a flat form and has a form of a lateral gradient, the height of which decreases as it goes toward the road boundary 110. This lateral gradient is provided to allow water to be easily discharged without being gathered on the paved road in the case of rain. Further, the non-paved area 120 is lower than the paved road surface 130 by the height of the pavement of the paved road surface 130 with respect to the road boundary 110. That is, a step exists between the paved road surface 130 and the unpaved road surface 120 next to the paved road portion. Further, the non-paved area 120 also is not flat, and the height of the non-paved area 120 may decrease as it becomes farther from the road boundary 110.

Reference numeral ‘140’ is an imaginary line (hereinafter, a danger line) for indicating a danger area, and if the vehicle enters the danger area 140, a preparation process, such as activation of sensors and collection of information from the sensors, for controlling a behavior of the vehicle according to the present disclosure is started.

Reference numeral ‘150’ denotes a scanning area of a laser scanner 30 with respect to the vehicle, and reference numeral ‘160’ denotes a photographing area of a camera installed on the front side of the vehicle.

In the above example, although the paved road of the four-lane has been described as an example, the number of lanes of the road does not influence the present disclosure, and any road will do as long as a time point at which the behavior control apparatus for a vehicle according to the present disclosure is operated and a process of assisting a steering manipulation of the driver by offsetting an external force generated due to geographical or geological differences between the paved road surface 130 and the non-paved area 120 has been described. Here, the steering manipulation of the driver refers to steering for returning the vehicle to the road.

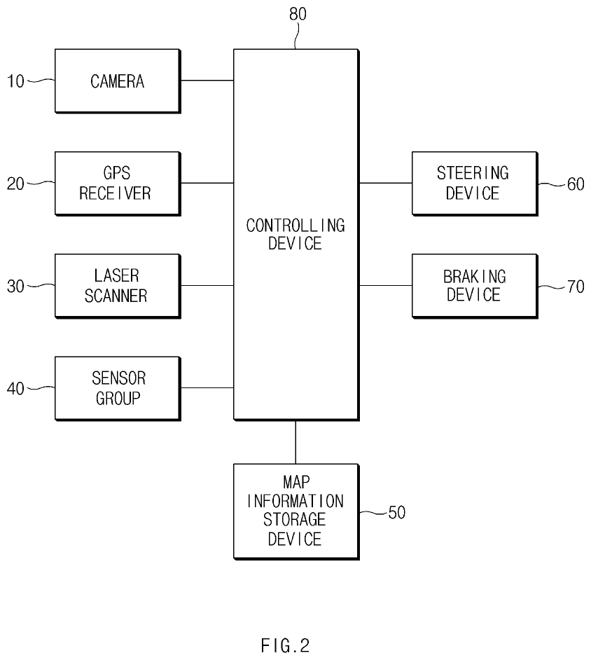

FIG. 2 is a diagram of an form of a behavior control system for a vehicle, to which the present disclosure is applied.

As illustrated in FIG. 2, the behavior control system for a vehicle may include a camera 10, a global positioning system (GPS) receiver 20, a laser scanner 30, a sensor group 40, a map information storage device 50, a steering device 60, a braking device 70, and a controlling device 80.

The camera 10 may include a front camera, a rear camera, a right camera, and a left camera, and an area photographed by the front camera corresponds to reference numeral ‘160’ of FIG. 1. The captured image includes a paved road surface 130, a non-paved area 120, a danger line 140, and a road boundary 110.

The GPS receiver 20 is a module for detecting a current location of the vehicle, and may be a GPS receiver included in a navigation device or a black box mounted on the vehicle.

The GPS receiver 20 receives signals from four or more of the satellites within an attention range and calculates a location of the vehicle. The GPS receiver 20 calculates distances between the satellites and the GPS receiver 20 and distance change rates by calculating time delays and Doppler shifts of the signals received from the satellites, and obtains the locations and speeds of the satellites from navigation data obtained by demodulating the received signals. If the information on the four or more satellites is obtained through the method, the location and speed of the GPS receiver may be obtained.

The GPS signal has a form in which navigation data of 50 Hz is modulated by a carrier signal of about 15 GHz in a PBSK method after the band of the navigation data is spread out with a natural pseudo-noise code of the satellite. Accordingly, the code and the carrier have to be removed to obtain the GPS signal from the GPS receiver 20 and data has to be demodulated. In order to remove the carrier, Doppler information on the size and direction of the Doppler shift has to be known, and generally, a Doppler shift of a maximum of 5 kHz is generated by a motion of the satellite when the GPS receiver 20 is stopped.

The Doppler information is generally derived through a method of discovering a signal at a specific interval. Meanwhile, the codes mixed in the GPS signal are classified into coarse acquisition (C/A) codes that may be received by civilians and precision (P) codes that are signals for the army, and different codes are multiplied for the satellites. The process of removing the code refers to a method of generating and convoluting the same code in the GPS receiver 20, and is performed at the same time when the Doppler discovering process is performed.

Data may be extracted after both the code and the carrier are removed. In the GPS data, five sub-frames form one frame and 25 frames form a super-frame. Because sub-frames 1, 2, and 3 of the data have values on the time and location of the satellite that transmitted GPS data, they are different for the satellites, and sub-frames 4 and 5 have information on all the satellites and sub-frames 4 and 5 for the satellites are the same. The location of the vehicle may be measured after the location and the measured value of the satellite is obtained by demodulating three or four pieces of satellite data via the above process.

The laser scanner 30 is provided in the vehicle to obtain laser scanner data around the vehicle and provide the obtained laser scanner data to the controlling device 80. The laser scanner data includes multiple lasers, and to achieve this, the laser scanner 30 may be a multi-layer laser scanner. In one form, the laser scanner 30 is a light detection and ranging (LiDar) laser radar, but the present disclosure is not limited thereto and various sensors and laser scanners corresponding thereto may be used.

As an example, the laser scanner 30 is a phase detection type laser scanner, and projects a laser beam corresponding to reference light to a distance measurement target object and detects reflected light that is reflected on a surface of the target object to return through a condensing lens. The reflected light detected in this way is compared with the reference light and a distance is measured by analyzing the phase difference between the reflected light and the reference light.

The laser scanner 30 may include a laser light source including a laser diode configured to generate reference light that is projected to a distance measurement target object, an optical signal detecting module configured to convert reflected light to an electrical signal to detect the reflected light, a signal processing module configured to process the electrical signal output from the optical signal detecting module to detect a phase difference between the reference light and the reflected light, an RMS detecting module configured to process an output signal of the signal processing module to detect a root mean squire (RMS), an addition/subtraction module configured to compare the RMS output from the RMS detecting module with a reference voltage to calculate the RMS, a proportional integration control module configured to perform a proportional integration according to calculation processing information received from the addition/subtraction module to output a control signal of a multiplication module, a modulation module connected to the multiplication module and configured to modulate the reference light to a sine wave, and a multiplication module configured to control output of the reference light irradiated by the laser light source according to a control signal of the proportional integration control module.

Although the laser scanner 30 has been exemplified in the form of the present disclosure, a radar may be additionally used.

The sensor group 40 refers to a group of various sensors configured to measure the dynamics of the vehicle, and, for example, may include a suspension stroke sensor, a gyro sensor, a wheel speed sensor, a steering angle sensor, a steering torque sensor, a force sensor, and wheel gravity (G) sensors. Then, the wheels G sensors may be mounted on both front wheels and rear wheels of the vehicle.

The suspension stroke sensor is a sensor configured to measure a distance by which a wheel moves from a full bump that is most shrunk as the wheel is popped up to a full rebound that is most prolonged.

The gyro sensor is a sensor configured to measure a change of the azimuth of an object by using a property of always maintaining a specific direction that is initially set with a high precision regardless of the rotation of the earth.

The wheel speed sensor is a sensor configured to measure a speed of a wheel.

The steering angle sensor is a sensor configured to measure a steering angle according to manipulation of a steering wheel of the driver.

The steering torque sensor is a sensor mounted on a steering shaft to measure a steering torque according to manipulation of a steering wheel of the driver.

The force sensor is a sensor mounted on a driving shaft (rack) of a wheel to measure a force delivered from a wheel.

The wheel G sensor is generally used for the purpose of detecting an impact applied to the vehicle, for example, in a black box.

The map information storage device 50 as a module that stores map information used in the navigation device may include a memory, such as a flash memory type, a hard disk type, a micro type, or a card type (for example, a secure digital (SD) card or an eXtream digital (XD) card), and a storage medium of at least one of memories, such as a random access memory (RAM), a static RAM (SRAM), a read-only memory (ROM), a programmable ROM (PROM), an electrically erasable PROM (EEPROM), a magnetic RAM (MRAM), a magnetic disk, and an optical disk.

The map information may include lateral gradients, a step between a road and a non-road, lane information (the number of lanes, the widths of the lanes, and the like), road curvature information, a median strip of a road, a guardrail of a road, a curb stone of a road, and a drain beside a road.

The controlling device 80 compensates for a behavior of the vehicle in consideration of an external force that is delivered from the one-side wheels when the one-side wheels of the vehicle, which is traveling on the road, deviates from the road (i.e., the paved road surface). That is, the controlling device 80 compensates for the behavior of the vehicle in consideration of the external force delivered from the one-side wheels due to the step (height difference) between the paved road surface and the unpaved road surface adjacent to the paved road surface, and the lateral gradient of the road.

The controlling device 80 controls the steering device 60 to additionally generate a steering torque corresponding to an external force delivered from the one-side wheels due to the step (height difference) between the road (i.e., the paved road surface) and the non-road (i.e., unpaved road surface adjacent to the paved road surface), and the lateral gradient of the road to assist a steering manipulation of the driver. Here, the steering manipulation of the driver refers to a manipulation of rotating a steering wheel such that the one-side wheels step onto the road.

Further, the controlling device 80 controls the braking device 70 to apply biased braking to the wheels located on the road such that a difference of the rolling resistances due to the step between the road and the non-road and the difference of the materials of the road and the non-road may be offset.

For reference, the rolling resistance is a rolling resistance applied when an object rotates on a contact surface, and occurs due to deformation of the contact surface. Whenever the wheels roll, the wheels (tires) are crushed and restored at every moment, and in the process, a rolling resistance occurs, energy of the wheels is lost, and the speed of the wheels decreases.

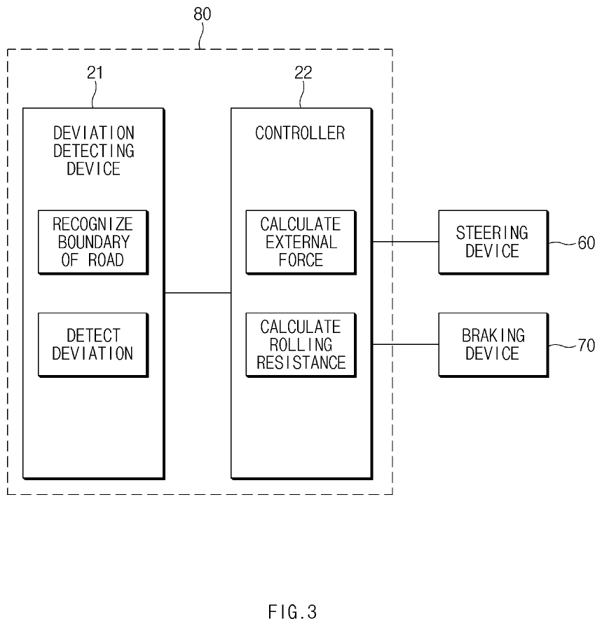

Hereinafter, a behavior control apparatus for a vehicle according to the present disclosure will be described below with reference to FIG. 3.

FIG. 3 is a diagram of one form of a behavior control apparatus for a vehicle according to the present disclosure.

As illustrated in FIG. 3, the behavior control apparatus may include a deviation detecting device 21 and a controller 22. The components may be coupled to each other into one according to a scheme of carrying out the present disclosure, and some components may be omitted according to the scheme of carrying out the present disclosure. That is, the function of the deviation detecting device 21 may be realized to be performed by the controller 22.

In a description of the components, first, the deviation detecting device 21 detects whether the wheels of the vehicle located on the paved road deviate from the road boundary 110 and enters the non-paved area 120.

The deviation detecting device 21 may recognize the road boundary 110 of the current road based on a current location of the vehicle acquired through the GPS receiver 20 and map information stored in the map information storage device 50, as a process of receiving the road boundary. Here, the deviation detecting device 21 may detect the road boundary 110 from a front image captured through the camera 10, based on the current location of the vehicle acquired through the GPS receiver 20 and the map information stored in the map information storage device 50.

Further, the deviation detecting device 21 may detect the road boundary 110 from the front image captured through the camera 10, based on the current location of the vehicle acquired through the GPS receiver 20, laser scanning data acquired through the laser scanner 30, and the map information stored in the map information storage device 50.

Further, the deviation detecting device 21 may calculate a step between the paved road surface 130 and the non-paved area 120 and a lateral gradient of the paved road surface 130, based on the front image captured through the camera 10 of the vehicle and the laser scanning data obtained through the laser scanner 30. Here, the step may be easily acquired through the laser scanner 30.

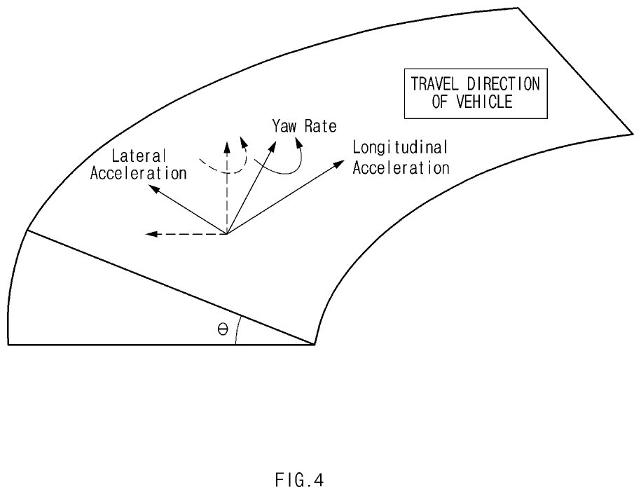

Hereinafter, a process of calculating a lateral gradient of the paved road surface 130 will be described in detail with reference to FIG. 4.

FIG. 4 is an exemplary view of a process of calculating a lateral gradient of a paved road surface used for the present disclosure.

As illustrated in FIG. 4, a lateral gradient indicates a direction of a coordinate system measured by a gyro sensor, a G sensor, and the like on a road having a lateral gradient, and a yaw rate and a lateral acceleration actually measured by the sensors are different from a yaw rate and a lateral acceleration when there is not lateral gradient due to a gradient angle θ of the road.

Accordingly, a yaw rate value measured from a road having a lateral gradient and a yaw rate value that is present on the same road when there is no lateral gradient have the following relationship.

Yaw rate′ of road having lateral gradient=Yaw rate of road having no lateral gradient×cos θ

In the same manner, a lateral G (lateral G′) having a lateral gradient is as follows.

(2) Lateral G (lateral G′) of road having lateral gradient=Lateral G (lateral G) having no lateral gradient/cos θ

Then, a radius (R_yr′) of curvature of a road calculated by the yaw rate′ having a lateral gradient and a radius (R_G′) of a road calculated by lateral G (lateral G′) having a lateral gradient are expressed in Equations 3 and 4.

(3) Radius (R_yr′) by yaw rate′=Vehicle speed (V)/yaw rate′

(4) Radius (R_G′) by lateral G′=V²/lateral G′

However, although the two values are the same when the road is flat, they are different on a road having a lateral gradient.

Accordingly, the radius of curvature on the road actually having a lateral gradient may be expressed as in Equations 5 and 6.

(5) R_yr′=V/yaw rate×cos θ

(6) R_G=V²/lateral G/cos θ

Accordingly, the radius of curvature of the road, the lateral gradient has been incremented, may be calculated in the following way.

One by yaw rate: V/yaw rate′×(1−cos θ)

One by lateral G: V²/lateral G′×(1/cos θ−1)

A difference between the yaw rate′ measured from the road having a lateral gradient and the radius of curvature by lateral G′ may be obtained in the following equation.

$${R\_G}^{′} - {R\_yr}^{′} = \frac{V}{{YawRate}^{′}} ( 1 - cos θ ) + \frac{{V}^{2}}{{LateralG}^{′}} ( \frac{1}{cos θ} - 1 ) \qquad [ Equation ]$$

Here, because yaw rate′ and lateral G′ may be obtained by the sensor group 40, a lateral gradient θ of the road may be obtained through the equation.

Further, the deviation detecting device 21 may detect deviation of the vehicle based on a change of the behavior of the vehicle delivered through the tire driven on the non-paved area 120. Then, the change of the behavior is detected by the sensor group 40.

As an example, as a method that uses a wheel G sensor, it may be determined that the vehicle deviated from the paved road surface 130 when the values of the front and rear wheel G sensors in the deviation direction are monitored and a value of not less than a threshold value is detected. Further, it may be determined that vibration of wheels occurs due to deviation of the paved road surface 130 when a deviation of a front/rear wheel G sensor value in a deviation direction and a deviation of the front/rear wheel G sensor in an opposite direction are compared and the difference is not less than a reference value

As an example, as a method that uses a suspension stroke sensor, it may be determined that the vehicle deviated from the paved road surface 130 when suspension strokes of the front and rear wheels in the deviation direction are monitored and a value of not less than a threshold value is detected.

As another example, as a method that uses a wheel speed sensor, it may be determined that the vehicle deviates from the paved road surface 130 when a speed of the front and rear wheels in a deviation direction and a speed of the front and rear wheels on the road are compared and a difference of the wheel speed of the front/rear wheels of not less than a threshold value occurs (a slip occurs in the wheels on the non-paved road).

Of course, as a relatively simple method, deviation of the vehicle from the paved road may be determined based on an image captured through the camera and laser scanning data obtained through the laser scanner.

Next, the controller 22 performs an overall control such that the components may normally perform their functions. The controller 22 may be realized in a form of hardware or software, and may be present in a form of a combination of hardware and software. In one form, the controller 22 may be realized by a microprocessor, but the present disclosure is not limited thereto.

The controller 22 calculates an external force based on a value measured by the steering torque sensor and a value measured by the force sensor. That is, the controller 22 may calculate an external force based on a relationship table stored in its own memory (not illustrated).

Here, the relationship table records a value measured by the force sensor, which corresponds to a value measured by the steering torque sensor on the paved road. Accordingly, the controller 22 monitors a value measured by the force sensor, which corresponds to a value measured by the steering torque sensor, to detect an additional sensor as an external force.

For example, when it is assumed that the relationship table records that a steering torque is 5 and a force corresponding to the steering torque is 7, it is determined that an external force is 3 if the measured force is 10 in spite that the steering torque is 5.

As a result, the controller 22 controls the steering device 60 to additionally generate a steering torque corresponding to an external force delivered from the one-side wheels due to the step (height difference) between the road and the non-road and the lateral gradient of the road to assist a steering manipulation of the driver.

Further, the controller 22 controls the braking device 70 to apply biased braking to the wheels located on the road such that a difference of the rolling resistances due to the step between the road and the non-road and the difference of the materials of the road and the non-road may be offset.

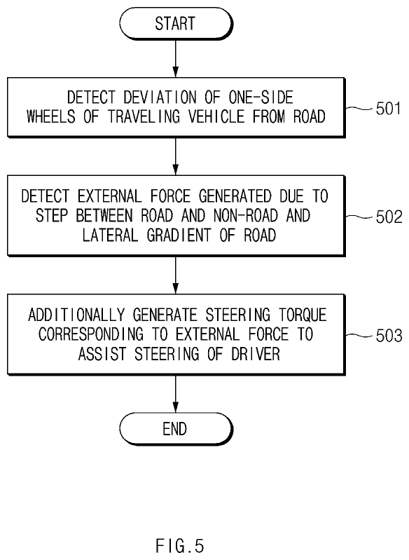

FIG. 5 is a flowchart of one form of a method for controlling a behavior of a vehicle according to the present disclosure.

First, the deviation detecting device 21 detects deviation of one-side wheels of the vehicle that is traveling from a road (501).

Thereafter, the controller 22 detects an external force generated due to a step between a road and a non-road and a lateral gradient of the road (502). Then, the controller 22 detects an external force based on a steering torque due to a manipulation of the steering wheel by the driver and a force delivered from the one-side wheels of the vehicle.

Thereafter, the controller 22 additionally generates a steering torque corresponding to the external force to assist steering of the driver (503). That is, the controller 22 controls the steering device 60 to additionally generate a steering torque corresponding to the external force.

According to the present disclosure, the driver may safely return the vehicle to the paved road by compensating for a behavior of the vehicle in consideration of an external force delivered from the one-side wheels as the one-side wheels of the vehicle, which is traveling on a road (namely, the paved road surface), deviates from the road.

Further, according to the present disclosure, the driver may safely return the vehicle to the paved road by compensating for a behavior of the vehicle in consideration of an external force delivered from the one-side wheels due to a step (height difference) between a road (namely, the paved road surface of the road) and a non-road (namely, the non-paved road surface of the road) and a lateral gradient of the road when the one-side wheels of the vehicle, which is traveling on the paved road surface, deviates from the paved road surface.

The above description is a simple exemplification of the technical spirit of the present disclosure, and the present disclosure may be variously corrected and modified by those skilled in the art to which the present disclosure pertains without departing from the essential features of the present disclosure.

Therefore, the disclosed forms of the present disclosure do not limit the technical spirit of the present disclosure but are illustrative, and the scope of the technical spirit of the present disclosure is not limited by the forms of the present disclosure. The scope of the present disclosure should be construed by the claims, and it will be understood that all the technical spirits within the equivalent range fall within the scope of the present disclosure.

What is claimed is:

1. A behavior control apparatus for a vehicle, the apparatus comprising:
a deviation detecting device configured to determine whether first-side wheels arranged on one side of the vehicle deviate from a first road surface of a road on which the vehicle travels; and
a controller configured to detect a first external force generated due to a step between the first road surface and a second road surface adjacent to the first road surface of the road, and configured to detect a lateral gradient of the road and to calculate and cause a steering torque corresponding to the first external force to assist steering of a driver.

2. The behavior control apparatus of claim 1, wherein the controller is configured to apply a biased braking to second-side wheels arranged opposite to the first-side wheels of the vehicle, and to offset a difference between rolling resistances caused by the step between the first road surface and the second road surface and by different materials on the first and second road surfaces.

3. The behavior control apparatus of claim 1, wherein the controller is configured to calculate a second external force based on a steering torque generated from manipulation of a steering wheel by the driver and a force delivered from the first-side wheels of the vehicle.

4. The behavior control apparatus of claim 1, wherein the deviation detecting device is configured to detect a road boundary from a front image of the vehicle based on a current location of the vehicle and map information.

5. The behavior control apparatus of claim 4, wherein the deviation detecting device is configured to determine the deviation of the vehicle from the first road surface based on a change to a movement of the vehicle generated when the first-side wheels across the road boundary.

6. The behavior control apparatus of claim 5, wherein the deviation detecting device is configured to determine that the first-side wheels of the vehicle deviated from the first road surface when a difference between a deviation of a gravitational acceleration of the first-side wheels of the vehicle and a deviation of a gravitational acceleration of second-side wheels arranged opposite to the first-side wheels of the vehicle exceeds a reference value.

7. The behavior control apparatus of claim 5, wherein the deviation detecting device is configured to determine that the first-side wheels of the vehicle deviated from the first road surface when a suspension stroke of the first-side wheels of the vehicle exceeds a threshold value.

8. The behavior control apparatus of claim 5, wherein the deviation detecting device is configured to determine that the first-side wheels of the vehicle deviated from the first road surface when a difference between a speed of the first-side wheels of the vehicle and a speed of second-side wheels arranged opposite to the first-side wheels of the vehicle exceeds a threshold value.

9. A method for controlling a behavior of a vehicle, the method comprising:
detecting deviation of first-side wheels of the vehicle, which is traveling, from a first road surface;
detecting a first external force generated due to a step between the first road surface and a second road surface adjacent to the first road surface of the road; detecting a lateral gradient of the road; and
calculating and causing a steering torque corresponding to the first external force to assist steering of a driver.

10. The method of claim 9, further comprising:
applying a biased braking to second-side wheels arranged opposite to the first-side wheels of the vehicle, and
offsetting a difference between rolling resistances caused by the step between the first road surface and the second road surface and by different materials on the first and second road surfaces.

11. The method of claim 9, wherein the detecting the first external force includes:
detecting a second external force based on a steering torque generated from manipulation of a steering wheel by the driver and a force delivered from the first-side wheels of the vehicle.

12. The method of claim 9, wherein the detecting the deviation includes:
detecting a road boundary from a front image of the vehicle based on a current location of the vehicle and map information.

13. The method of claim 12, wherein the detecting the deviation includes:
determining deviation of the vehicle from the first road surface based on a change to a movement of the vehicle generated when the first-side wheels across the road boundary.

14. The method of claim 13, wherein the detecting the deviation includes:
determining that the first-side wheels of the vehicle deviated from the first road surface when a difference between a deviation of a gravitational acceleration of the first-side wheels of the vehicle and a deviation of a gravitational acceleration of second-side wheels arranged opposite to the first-side wheels of the vehicle exceeds a reference value.

15. The method of claim 13, wherein the detecting the deviation includes:
determining that the first-side wheels of the vehicle deviated from the first road surface when a suspension stroke of the first-side wheels of the vehicle exceeds a threshold value.

16. The method of claim 13, wherein the detecting the deviation includes:
determining that the first-side wheels of the vehicle deviated from the first road surface when a difference between a speed of the first-side wheels of the vehicle and a speed of second-side wheels arranged opposite to the first-wheels of the vehicle exceeds a threshold value.
